(19) United States
(12) Patent Application Publication
(10) Pub. No.: US 2001/0029586 A1
(43) Pub. Date: Oct. 11, 2001

(54) Apparatus comprising a keypad and method of protecting keys against unwanted intrusions

(76) Inventor: Francois Coutant, Mulsanne (FR)

Correspondence Address: Corporate Patent Counsel, U.S. Philips Corporation, 580 White Plains Road, Tarrytown, NY, 10591, US

(21) Appl. No.: 09/795,001

(22) Filed: Feb. 28, 2001

(30) Foreign Application Priority Data
Feb. 29, 2000 (FR) 0002555

(51) Int. Cl. H04L 9/00; H04L 9/32; G06F 11/30; G06F 12/14

(52) U.S. Cl. 713/202

(57) ABSTRACT

A proposal is made to lock the keypad by depressing keys (10, 11, 12 . . . ). However, to avoid inappropriate use of the apparatus, a sequence of keys called secret key sequence is to be depressed for the apparatus to become operational. In an advantageous manner this sequence is determined by the PIN code contained in the SIM card (30). Application to cellular telephony mobiles.

The invention relates to an apparatus comprising a keypad and means for activating and deactivating said keypad.

The invention finds highly significant applications notably in the field of mobile telephones which form part of a cellular network. In this type of apparatus it has been found necessary to block and thus deactivate the keypad to avoid an accidental depression of one of the keys creating inappropriate effects such as, for example, the alteration of the address book or emergency call, although it is not necessary to proceed to such a call.

The invention also relates to a method of protecting a keypad against untimely depressing keys, which is suitable for an apparatus described above.

Such an apparatus is known from European patent document published under no. 0 453 089. By depressing a sequence of two keys, the keypad is blocked and by depressing these same keys the keypad is unblocked.

The apparatus known from this document has the drawback that this sequence is known and that an impertinent third party can use the telephone apparatus and make a call at the cost of its legitimate proprietor.

The present invention proposes an apparatus of the type defined in the opening paragraph, which provides a protection against unwanted effects of inappropriately touching the keys and which offers a protection against fraudulent use of the apparatus.

For this purpose, such an apparatus is characterized in that the activation means are controlled by an activation password.

A method of the type defined above is characterized in that the keyboard is deactivated by means of a first deactivation action and in that it is activated by means of a sequence of key depressions, qualified as a secret key sequence.

Thus, since the activation code is rather secret, the apparatus is thus well protected against malicious actions of slightly scrupulous third parties.

An embodiment according to which the deactivation means are independent of the call reception means offers the advantage that the apparatus is available for signaling a return call.

An embodiment of the method in accordance with the invention which is suitable for an apparatus that satisfies the GSM standard is characterized in that the activation of said keypad calls for the CHV1 code of said standard. Thus the additional advantage is obtained that implementing the invention does not imply any additional hardware.

These and other aspects of the invention are apparent from and will be elucidated, by way of non-limitative example, with reference to the embodiment(s) described hereinafter.

In the drawings:

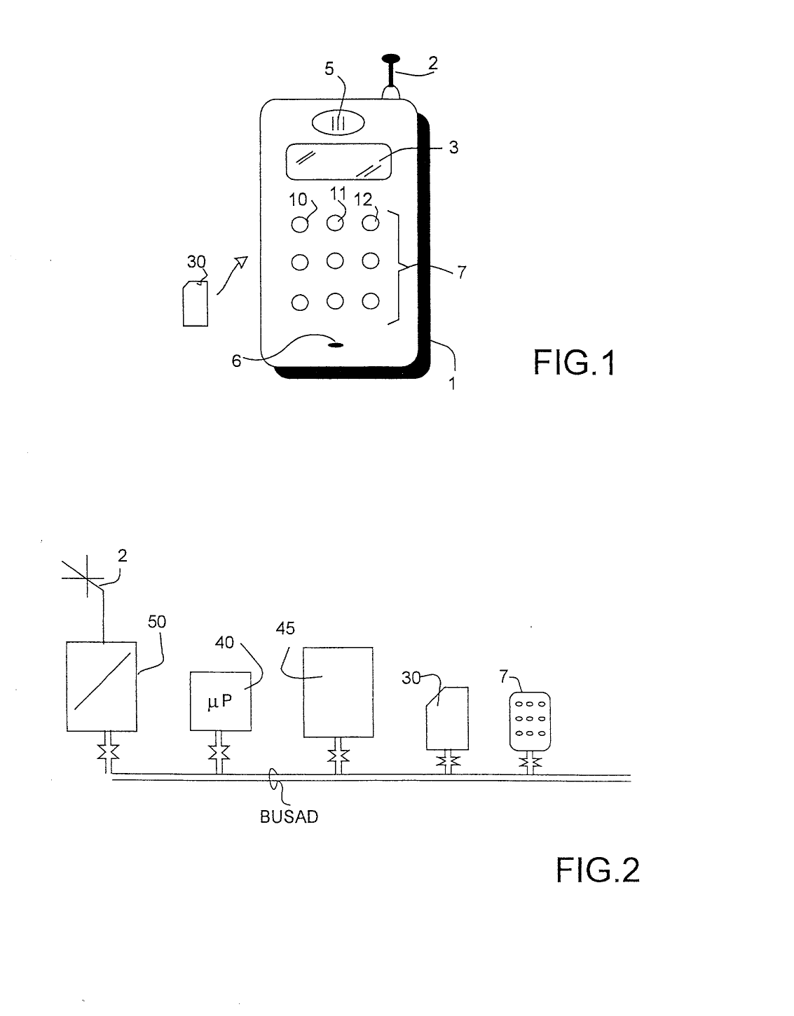

FIG. 1 shows an apparatus in accordance with the invention,

FIG. 2 shows the diagram of the apparatus shown in FIG. 1 and

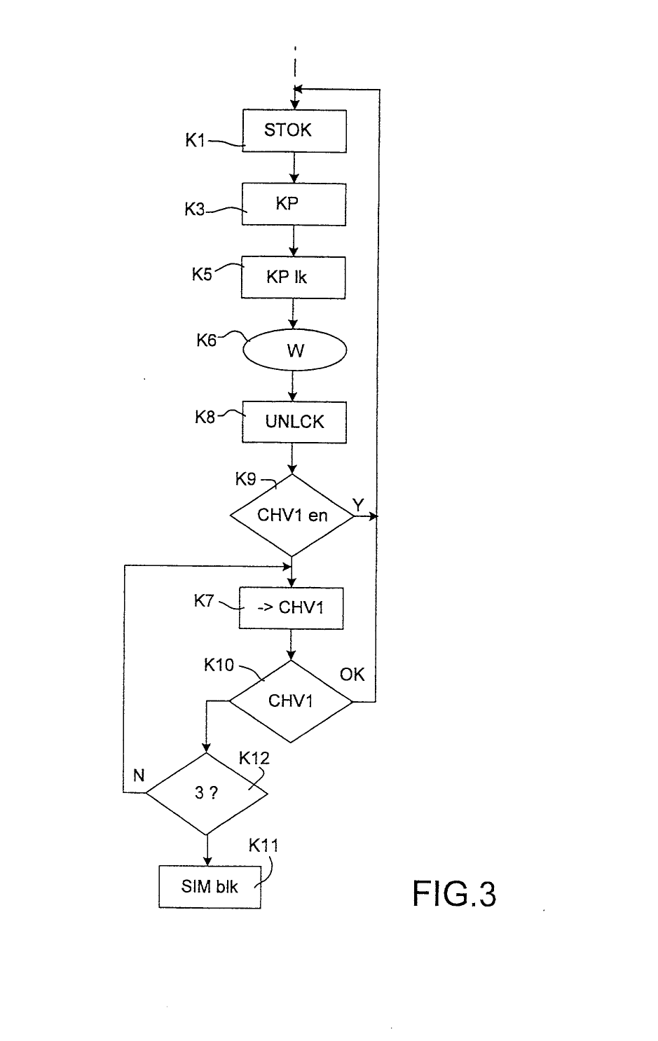

FIG. 3 shows a flow chart explaining the operation of the apparatus.

In FIG. 1 is shown a mobile telephone formed by a housing 1 comprising, notably, an antenna 2, a screen 3, a loudspeaker 5, a microphone 6, a keypad 7 and various other operation keys 10, 11, 12 . . . . Some information about the user is contained in a SIM card 30 which is accommodated at the back of the apparatus. This SIM card 30 is very often used in apparatus intended to communicate in cellular networks of the GSM type. In this respect the standards of this system may be consulted.

FIG. 2 shows an operation diagram of the apparatus. The elements held in common with those of the preceding Figure carry the same references. The operation of the invention is defined by a processor assembly comprising the processor 40 which works together with a memory 45 and also with the SIM card 30. All these elements are interconnected by a common line BUSAD. For controlling other elements of the apparatus the line BUSAD is connected both to the keypad 7 and to the transceiver assembly 50 of the apparatus.

In accordance with the invention the keypad is unblocked, thus activated, by means of a secret password. Preferably this password is the PIN code written in the SIM card. In other words, the same procedure is carried out as for the switching on of the apparatus.

When the keyboard is deactivated, the transceiver assembly is still capable of receiving calls. Although it is said that the keypad is deactivated, it is still possible to make a sequence of key depressions that corresponds to the PIN code of the SIM card which constitutes a user identification medium.

FIG. 3 shows a flow chart, which explains the operation of the apparatus. Box K1 on this flow chart indicates the normal state of operation of the apparatus, that is to say, that all its functions are at the user's disposal. When the user wishes to block his keypad, he depresses a sequence of keys or a single key, which is indicated in box K3. Then the locked state is proceeded to (box K5).

The use of the PIN code within the framework of the invention is rendered very simple thanks to a series of commands including “VERIFY CHV and STATUS” described in the GSM standard ETS 300 608. So there is no need to provide additional hardware.

Once the keypad is blocked (box K5), the mobile waits for an action (box K6). This may be an incoming call, an emergency call, but also the depressing of the key (or sequence of keys) for unblocking the keypad (box K8). Once the command to unblock the keypad has been given, the mobile checks whether the CHV1 is activated or not (box K9) thanks to the command STATUS. This command reflects the state of the CHV1 (blocked or unblocked, Enable or Disable).

If the CHV1 is activated, the user is to enter his PIN code. With this code the mobile addresses the command “VERIFY CHV1” to the SIM card (box K10) and if the response from the SIM card is correct, the normal state of operation is proceeded to. If not, one goes back to the state in which CHV1 is enabled (box K7).

If the test of the box K9 produces the information STATUS which shows that the procedure CHV1 is disabled, this means that the user does not make use of the PIN code to protect his SIM card. In that case there is no need to ask the user for his PIN code and box K1 is thus returned to.

After 3 vain attempts (box K12) to acquire the PIN code, the SIM card is blocked (box K11) and a special unblocking code known to the operator is necessary for unblocking the card.

1. An apparatus comprising a keypad and means for enabling and disabling said keypad, characterized in that the enabling means are controlled by an enable password.

2. An apparatus as claimed in claim 1, characterized in that the disable means are controlled by a disable password.

3. An apparatus as claimed in claim 1, whose functioning depends on information contained in an identification medium, characterized in that at least the disabling password is contained in this medium.

4. An apparatus as claimed in one of the claims 1 to 3, characterized in that the deactivation means are independent of call reception means.

5. A method of protecting a keypad against unwanted key depressions, suitable for an apparatus as claimed in one of the claims 1 to 4, characterized in that the keypad is disabled by means of a first disabling action and in that it is enabled by means of a sequence of key depressions qualified as secret.

6. A method as claimed in claim 5, suitable for an apparatus which has an identification medium containing an identification code, characterized in that said secret sequence is defined by said identification code.

7. A method as claimed in claim 6, suitable for an apparatus that satisfies the GSM standard.

8. A method as claimed in claim 7, characterized in that enabling said keypad calls for the CHV procedure of said standard.
